(19) United States
(12) Patent Application Publication
(10) Pub. No.: US 2010/0191460 A1
(43) Pub. Date: Jul. 29, 2010

(54) Method, Device, And System For Overlaying Track Points On An Electronic Map

(75) Inventor: Al Lai, Chung Ho City (TW)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: WINTECRONICS, LTD., Chung Ho City (TW)

(21) Appl. No.: 12/361,431

(22) Filed: Jan. 28, 2009

(51) Int. Cl. G01C 21/00; G09G 5/00

(52) U.S. Cl. 701/208; 345/634

(57) ABSTRACT

A method for overlaying track points on an electronic map includes: enabling a positioning device to receive a plurality of track points, and to record a tracklog, which includes the track points received thereby; establishing a connection between the positioning device and a computer; and enabling the computer to automatically execute a map-making software stored in the positioning device, which enables the computer to overlay the track points in the tracklog on an electronic map. Device and system for performing the method are also disclosed.

### BACKGROUND OF THE INVENTION

1. Field of the Invention

This invention relates to a method, device, and system for overlaying track points received from a global positioning system (GPS) service provider on an electronic map.

2. Description of the Related Art

FIG. 1 illustrates a conventional global positioning system (GPS) receiver 9 that includes a microprocessor 90, a track point-receiving module 91, a storage module 93, and an interface module 92. Each of the track point-receiving module 91, the storage module 93, and the interface module 92 is connected to the microprocessor 90. The track point-receiving module 91 is operable so as to receive a plurality of track points, such as those from a GPS service provider (not shown). The microprocessor 90 is operable so as to record a tracklog 931 in the storage module 93, which includes the track points received by the track point-receiving module 91. The tracklog 931 may be downloaded from the conventional GPS receiver 9 into a computer 8 and the track points therein may be superimposed on an electronic map (not shown) with the aid of a map-making software (not shown).

The aforementioned conventional GPS receiver 9 is disadvantageous in that, after connecting the conventional GPS receiver 9 to the computer 8 via the interface module 92 thereof, the user has to manually install and execute the map-making software. Aside from that, prior to the connection of the conventional GPS receiver 9 to the computer 8, the user has to install a device driver for the conventional GPS receiver 9 to be able to be recognized by the computer 8, as illustrated in FIG. 2.

### SUMMARY OF THE INVENTION

Therefore, the main object of the present invention is to provide a method that overlays track points on an electronic map without user intervention.

Another object of the present invention is to provide device and system that perform the method.

According to an aspect of the present invention, a method for overlaying track points on an electronic map comprises:

A) enabling a positioning device to receive a plurality of track points, and to record a tracklog, which includes the track points received thereby;

B) establishing a connection between the positioning device and a computer; and

C) enabling the computer to automatically execute a map-making software stored in the positioning device, which enables the computer to overlay the track points in the tracklog recorded in step A) on an electronic map.

According to another aspect of the present invention, a positioning device for overlaying track points on an electronic map comprises a positioning module, a storage module, a processing unit, and an interface module. The positioning module is operable so as to receive a plurality of track points. The storage module stores map-making software, and an autorun file that defines the map-making software. The processing unit is coupled to the positioning module and the storage module, and is operable so as to record a tracklog in the storage module, the tracklog including the track points received by the positioning module. The interface module is coupled to the storage module, is adapted to be coupled to a computer, and when coupled to the computer, enables the computer to automatically read the autorun file stored in the storage module. The autorun file, when read, enables the computer to automatically execute the map-making software stored in the storage module. The map-making software, when executed, enables the computer to overlay the track points in the tracklog recorded in the storage module on an electronic map.

According to yet another aspect of the present invention, a system for overlaying track points on an electronic map comprises a computer and a positioning device. The positioning device includes a positioning module, a storage module, a processing unit, and an interface module. The positioning module is operable so as to receive a plurality of track points. The storage module stores map-making software, and an autorun file, which defines the map-making software. The processing unit is coupled to the positioning module and the storage module, and is operable so as to record a tracklog in the storage module, the tracklog including the track points received by the positioning module. The interface module is coupled to the storage module, and when coupled to the computer, enables the computer to automatically read the autorun file stored in the storage module. The autorun file, when read, enables the computer to automatically execute the map-making software stored in the storage module. The map-making software, when executed, enables the computer to overlay the track points in the tracklog recorded in the storage module on an electronic map.

### BRIEF DESCRIPTION OF THE DRAWINGS

Other features and advantages of the present invention will become apparent in the following detailed description of the preferred embodiment with reference to the accompanying drawings, of which:

FIG. 1 is a block diagram of a conventional global positioning system (GPS) receiver for overlaying track points on an electronic map;

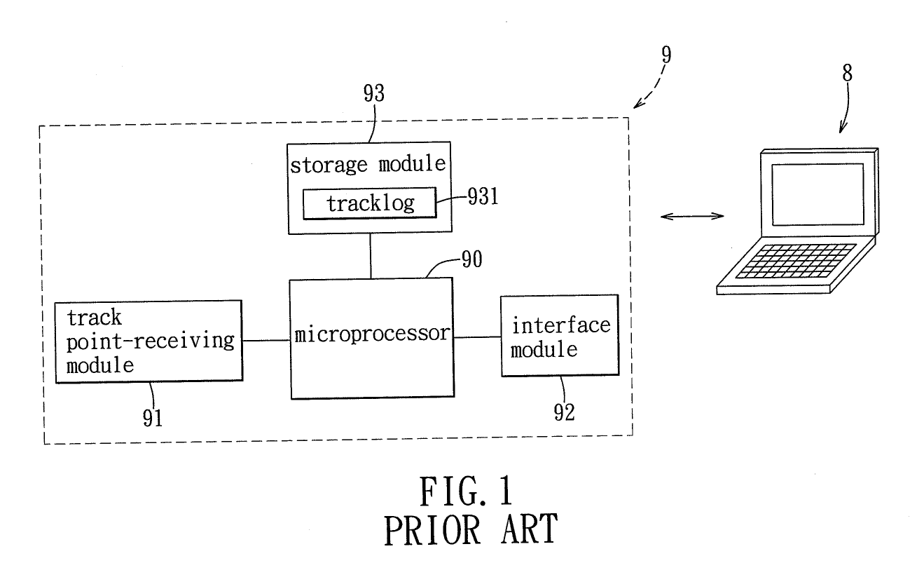

FIG. 2 is a schematic diagram illustrating the conventional GPS receiver recognized as a GPS receiver in a device manager under a control panel of an operating system;

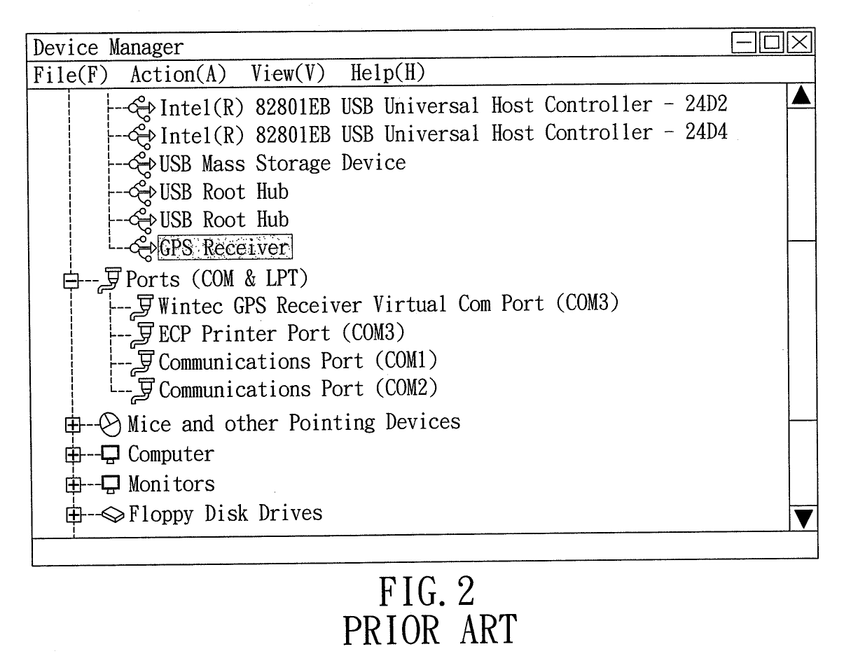

FIG. 3 is a block diagram of the preferred embodiment of a system for overlaying track points on an electronic map according to this invention;

FIG. 4 is a flow chart of the preferred embodiment of a method for overlaying track points on an electronic map to be implemented using the system in FIG. 3; and

FIG. 5 is a schematic diagram illustrating a positioning device of the preferred embodiment recognized as a universal serial bus (USB) mass storage device in a device manager under a control panel of an operating system.

### DETAILED DESCRIPTION OF THE PREFERRED EMBODIMENT

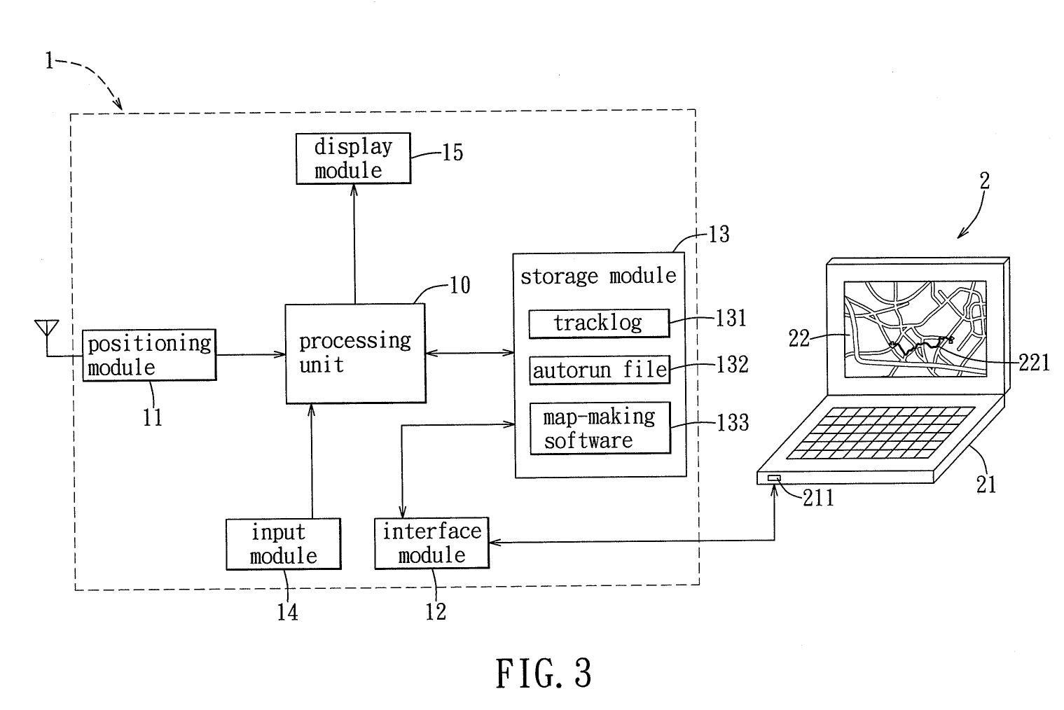

Referring to FIG. 3, the preferred embodiment of a system for overlaying track points on an electronic map according to this invention is shown to include a computer 2 and a positioning device 1.

The computer 2 includes a system unit 21 and a display unit 22.

The positioning device 1 of this embodiment is configured as a storage device, and includes a positioning module 11, a storage module 13, a processing unit 10, and an interface module 12.

In an alternative embodiment, the positioning device 1 may be configured as an MP3 player or a digital camera.

The positioning module 11 is operable so as to receive a plurality of track points, such as from a global positioning system (GPS) service provider (not shown).

The storage module 13 stores map-making software 133, and an autorun file 132 that defines the map-making software 133.

The processing unit 10 is coupled to the positioning module 11 and the storage module 13, and is operable so as to record a tracklog 131 in the storage module 13. The tracklog 131 includes the track points received by the positioning module 11. In this embodiment, the processing unit 10 includes the track points in the tracklog 131 recorded in the storage module 13 in a National Marine Electronics Association (NMEA) 0183 format. Moreover, in this embodiment, the processing unit 10 further includes coordinates, altitude, speed, and direction of each of the track points in the tracklog 131 recorded in the storage module 13.

The map-making software 133, the filename of which is trans_map.exe, when executed, enables the system unit 21 of the computer 2 to overlay the track points in the tracklog 131 recorded in the storage module 13 on an electronic map 221, which is thereafter displayed on the display unit 22 of the computer 2. In this embodiment, the electronic map 221 may be a computer-generated map, an aerial-captured photographic map, or a satellite-captured photographic map.

The autorun file 132, the filename of which is autorun.inf, when read, enables the system unit 21 of the computer 2 to automatically execute the map-making software 133. In this embodiment, the contents of the autorun file 132 are as follows:
open=trans_map.exe
shellexecute=trans_map.exe
shell\auto\command=trans_map.exe

The interface module 12 is directly connected to the storage module 13, and complies with a wired interface module standard established for a universal serial bus (USB) interface module.

In an alternative embodiment, the interface module 12 may be an RS-232, a secure digital (SD), a personal computer memory card international association (PCMCIA), or a PS/2 compliant interface module.

In yet another embodiment, the interface module 12 complies with a wireless interface module standard established for a Bluetooth interface module.

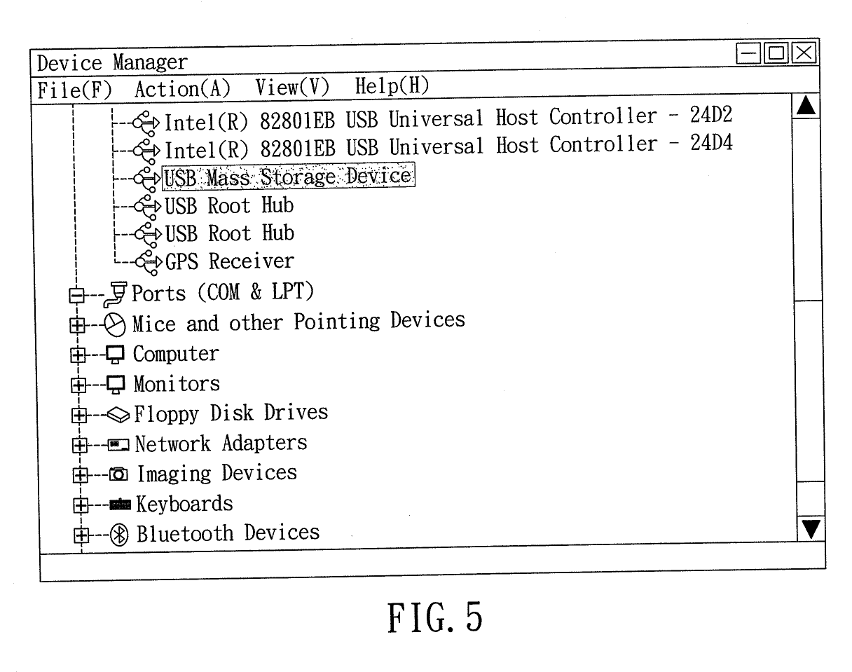

From the above description, since the positioning device 1 is configured as a storage device, i.e., the interface module 12 of the positioning device 1 is directly connected to the storage module 13 of the positioning device 1, and since the interface module 12 of the positioning device 1 is a USB-compliant interface module, when the interface module 12 of the positioning device 1 is connected to an interface module 211 of the system unit 21 of the computer 2, the positioning device 1 is automatically recognized as a USB mass storage device by the system unit 21 of the computer 2, as illustrated in FIG. 5, thereby sparing the user from the trouble of installing a device driver for the positioning device 1 in the system unit 21 of the computer 2.

Furthermore, since the positioning device 1 is recognized as a USB mass storage device by the system unit 21 of the computer 2, the system unit 21 of the computer 2 automatically reads the autorun file 132, i.e., the autorun.inf, stored in the storage module 13 of the positioning device 1, whereby the system unit 21 of the computer 2 automatically executes the map-making software 133, i.e., the trans_map.exe, stored in the storage module 13 of the positioning device 1, thereby sparing the user from the trouble of manually installing and executing the map-making software 133.

The positioning device 1 further includes an input module 14, a sensing module (not shown), and a display module 15, each of which is connected to the processing unit 10.

The input module 14 is operable so as to control setting of conditions by the processing unit 10 on which a track point is included by the processing unit 10 in the tracklog 131 recorded in the storage module 13.

The sensing module detects brightness, temperature, and air pressure of the surroundings of the positioning device 1, and roll, pitch, and yaw of the positioning device 1, which are thereafter sent to the processing unit 10.

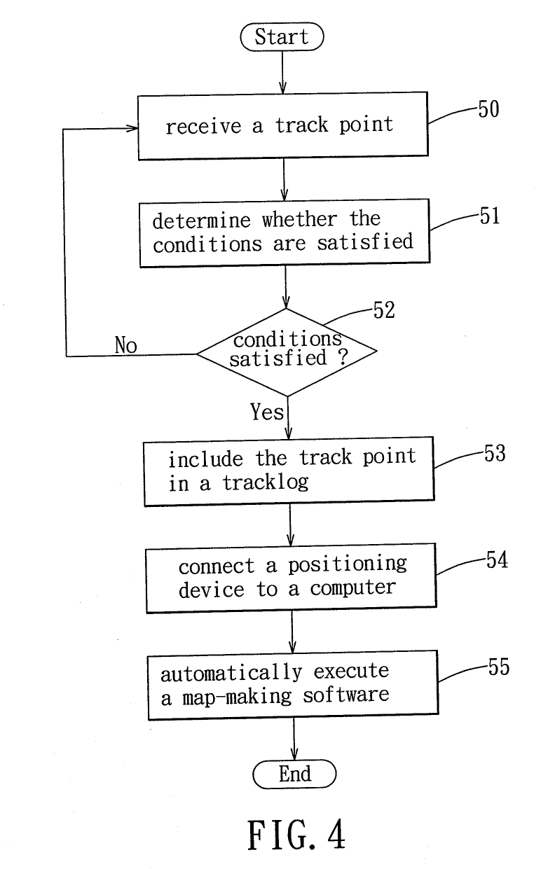

The preferred embodiment of a method for overlaying track points on an electronic map to be implemented using the aforementioned system according to this invention will now be described with further reference to FIG. 4.

In step 50, the positioning module 11 of the positioning device 1 receives a track point.

In step 51, the processing unit 10 of the positioning device 1 determines whether the conditions set thereby are satisfied.

In step 52, when it is determined in step 51 that the conditions are satisfied, the flow proceeds to step 53. Otherwise, the processing unit 10 ignores the track point received in step 50 and the flow goes back to step 50.

In step 53, the processing unit 10 of the positioning device 1 includes the track point received in step 50 in the tracklog 131 recorded thereby in the storage module 13 of the positioning device 1.

In step 54, the interface module 12 of the positioning device 1 is connected to the interface module 211 of the system unit 21 of the computer 2.

In step 55, the system unit 21 of the computer 2 automatically reads the autorun file, i.e., the autorun.inf, stored in the storage module 13 of the positioning device 1, as a result of which the system unit 21 of the computer 2 automatically executes the map-making software 133, i.e., the trans_map.exe, stored in the storage module 13 of the positioning device 1.

The method further includes the following steps:

56) the display module 15 of the positioning device 1 displays a dialog, which prompts the user to select one of a setting mode and a receiving mode;

57) when it is determined in step 56 that the setting mode is selected, the flow proceeds to step 58. Otherwise, when it is determined in step 56 that the receiving mode is selected, the flow goes back to step 50; and

58) the processing unit 10 of the positioning device 1 sets conditions on which a track point is included in the tracklog 131 recorded in the storage module 13 of the positioning device 1. Thereafter, the flow goes back to step 56.

In this embodiment, the conditions for direction, speed, acceleration, and altitude of a track point, brightness, temperature, and air pressure of the surroundings of the positioning device 1, roll, pitch, and yaw of the positioning device 1, time interval between two track points, and distance between two track points are set.

The method further includes the following steps:

59) the processing unit 10 of the positioning device 1 determines a change from a latest one of the track points in the tracklog 131 recorded in the storage module 13 of the positioning device 1 within a predetermined time period;

60) when the processing unit 10 of the positioning device 1 does not detect a change from the latest track point in step 59, the flow proceeds to step 61. Otherwise, the flow goes back to step 50;

61) the processing unit 10 of the positioning device 1 enters asleep mode, during which the positioning module 11 of the positioning device 1 is disabled from receiving the track points;

62) the processing unit 10 of the positioning device 1 determines occurrence of a wake-up event; and

63) when the processing unit 10 of the positioning device 1 determines the occurrence of the wake-up event in step 62, the positioning module 11 of the positioning device 1 is enabled to resume receiving the track points.

In this embodiment, the occurrence of the wake-up event is determined when the processing unit 10 of the positioning device 1 detects a vibration, a light, or a change in roll, pitch, or yaw thereof.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A method for overlaying track points on an electronic map, comprising:
A) enabling a positioning device to receive a plurality of track points, and to record a tracklog, which includes the track points received thereby;
B) establishing a connection between the positioning device and a computer; and
C) enabling the computer to automatically execute a map-making software stored in the positioning device, which enables the computer to overlay the track points in the tracklog recorded in step A) on an electronic map.

2. The method as claimed in claim 1, further comprising:
D) configuring the positioning device as a storage device, such that, in step B), the computer recognizes the positioning device as a storage device, and such that, in step C), the computer automatically executes the map-making software upon recognizing the positioning device.

3. The method as claimed in claim 1, further comprising:
D) setting a condition on which the positioning device includes a track point in the tracklog recorded in step A).

4. The method as claimed in claim 3, wherein the condition for at least one of direction, speed, acceleration, altitude, brightness, temperature, air pressure, roll, pitch, yaw, time interval between two track points, and distance between two track points is set in step D).

5. The method as claimed in claim 1, further comprising:
D) enabling the positioning device to detect a change from a latest one of the track points in the tracklog recorded in step A) within a predetermined time period; and
E) when the positioning device does not detect a change from the latest one of the track points in step D), enabling the positioning device to enter a sleep mode, during which the positioning device is disabled from receiving the track points.

6. The method as claimed in claim 5, further comprising:
F) when the positioning device is in the sleep mode, enabling the positioning device to determine occurrence of a wake-up event; and
G) when the occurrence of the wake-up event is determined in step F), enabling the positioning device to resume receiving the track points.

7. The method as claimed in claim 6, wherein the occurrence of the wake-up event is determined in step F) when the positioning device detects at least one of a vibration, a light, and a change in one of roll, pitch, and yaw thereof.

8. The method as claimed in claim 1, wherein, in step C), the electronic map is one of a computer-generated map, an aerial-captured photographic map, and a satellite-captured photographic map.

9. The method as claimed in claim 1, wherein the tracklog recorded in step A) further includes at least one of coordinates, altitude, speed, and direction of each of the track points therein.

10. A positioning device for overlaying track points on an electronic map, comprising:
a positioning module operable so as to receive a plurality of track points;
a storage module storing map-making software, and an autorun file that defines the map-making software;
a processing unit coupled to said positioning module and said storage module, and operable so as to record a tracklog in said storage module, the tracklog including the track points received by said positioning module; and
an interface module coupled to said storage module, adapted to be coupled to a computer, and when coupled to said computer, enables the computer to automatically read the autorun file stored in said storage module;
wherein the autorun file, when read, enables the computer to automatically execute the map-making software stored in said storage module; and
wherein the map-making software, when executed, enables the computer to overlay the track points in the tracklog recorded in said storage module on an electronic map.

11. The positioning device as claimed in claim 10, wherein said interface module is directly connected to said storage module.

12. The positioning device as claimed in claim 10, further comprising an input module coupled to said processing unit, and enabling said processing unit to set a condition on which a track point is included in the tracklog recorded by said processing unit.

13. The positioning device as claimed in claim 12, wherein said processing unit sets the condition for at least one of direction, speed, acceleration, altitude, brightness, temperature, air pressure, roll, pitch, yaw, time interval between two track points, and distance between two track points.

14. The positioning device as claimed in claim 10, wherein said processing unit is further operable so as to determine a change from a latest one of the track points in the tracklog recorded in said storage module within a predetermined time period, and when said processing unit does not detect a change from the latest one of the track points, said processing unit enters a sleep mode, during which said positioning module is disabled from receiving the track points.

15. The positioning device as claimed in claim 14, wherein said processing unit determines occurrence of a wake-up event when in the sleep mode, and said positioning module is enabled to resume receiving the track points when the occurrence of the wake-up event is detected by said processing unit.

16. The positioning device as claimed in claim 15, wherein said processing unit determines the occurrence of the wake-up event when at least one of a vibration, a light, and a change in roll, pitch, and yaw thereof is detected thereby.

17. The positioning device as claimed in claim 10, wherein said interface module complies with one of wired and wireless interface module standards.

18. The positioning device as claimed in claim 10, wherein said processing unit further includes at least one of coordinates, altitude, speed, and direction of each of the track points in the tracklog recorded in said storage module.

19. A system for overlaying track points on an electronic map, comprising:
a computer; and
a positioning device including
a positioning module that is operable so as to receive a plurality of track points,
a storage module that stores map-making software, and an autorun file, which defines the map-making software,
a processing unit that is coupled to said positioning module and said storage module, and that is operable so as to record a tracklog in said storage module, the tracklog including the track points received by said positioning module, and
an interface module that is coupled to said storage module, and that when coupled to said computer, enables said computer to automatically read the autorun file stored in said storage module;
wherein the autorun file, when read, enables said computer to automatically execute the map-making software stored in said storage module; and
wherein the map-making software, when executed, enables said computer to overlay the track points in the tracklog recorded in said storage module on an electronic map.

20. The system as claimed in claim 19, wherein said interface module is connected directly to said storage module.

21. The system as claimed in claim 19, wherein the electronic map on which said computer overlays the track points is one of a computer-generated map, an aerial-captured photographic map, and a satellite-captured photographic map.

22. The system as claimed in claim 19, wherein said interface module complies with one of wired and wireless interface module standards.

23. The system as claimed in claim 19, wherein said processing unit further includes at least one of coordinates, altitude, speed, and direction of each of the track points in the tracklog recorded in said storage module.
